(19) United States
(12) Patent Application Publication
(10) Pub. No.: US 2013/0159977 A1
(43) Pub. Date: Jun. 20, 2013

(54) OPEN KERNEL TRACE AGGREGATION

(71) Applicants: Christopher Crosetto, Kirkland, WA (US); Akshay Johar, Bellevue, WA (US); Brian Ewanchuk, Redmond, WA (US); Shane Guillet, Seattle, WA (US); Karen Franco, Kirkland, WA (US); Austin Lamb, Bellevue, WA (US); Danial Zaki, Bothell, WA (US)

(72) Inventors: Christopher Crosetto, Kirkland, WA (US); Akshay Johar, Bellevue, WA (US); Brian Ewanchuk, Redmond, WA (US); Shane Guillet, Seattle, WA (US); Karen Franco, Kirkland, WA (US); Austin Lamb, Bellevue, WA (US); Danial Zaki, Bothell, WA (US)

(73) Assignee: MICROSOFT CORPORATION, Redmond, WA (US)

(21) Appl. No.: 13/325,074

(22) Filed: Dec. 14, 2011

(51) Int. Cl. G06F 9/44

(52) U.S. Cl. 717/128

(57) ABSTRACT

A kernel trace system is described that acts as a kernel driver to insert traces into an open system kernel using existing kernel probe application-programming interfaces (APIs) and copies these events to an existing logging module for transfer to user space. The new module aggregates kernel traces to a performance logging module. A performance logging module can be extended with the kernel trace system herein to include new events in an open kernel not originally included in the implementation of the performance logging module. In this way, the kernel trace system can cause events to be logged that were not logged in the kernel as provided by the operating system vendor, and can do so without requiring that a new version of the operating system be built. The probes can be inserted dynamically at run time on an existing kernel to extract additional trace information.

### BACKGROUND

Operating system kernels provide the core functionality of an operating system. The kernel is often responsible for managing memory and assigned each running application a portion of the memory, determining how applications are distributed across physical processor resources, managing application concepts such as processes and threads, managing access to other resources (e.g., files, networks, specialized hardware, and so forth), loading and invoking hardware drivers, and so on. Each operating system typically has a different kernel architecture though there are similarities between them. MICROSOFT™ WINDOWS™, Linux, Mac OS X, and many other operating systems each have their own kernel and associated architecture.

It is often useful to receive trace information that explains or logs what the kernel is doing at a particular time or in response to particular events. This can be useful for developers of the kernel, for driver developers writing drivers that are loaded and invoked by the kernel, for developers developing performance tools that need to query kernel timestamps, and by application developers debugging difficult problems. Hardware makers may use kernel trace information to identify interactions between the hardware and kernel, to identify interactions between kernel and user space, and to identify memory leaks or other faults. Kernel trace information comes with a performance penalty, and to allow the kernel to be very efficient operating system vendors often provide little trace information. Some operating system vendors provide checked and retail builds of the kernel, where the retail build is fast with few traces and the checked build includes many more instances of logging trace information. This information may be logged using a debug trace function or other facility provided by the operating system and may be captured by applications that view debug trace information (e.g., debuggers or trace consoles).

Because each operating system is proprietary and architected differently, it is difficult for developers writing software designed to be run on various operating systems to ensure the same level of trace information is available on each operating system. Often, developers construct a different system for each architecture to analyze and test their software. This can be particularly frustrating for software bugs that only show up on one platform, especially when that platform does not provide a similar tool that would help diagnose the problem on other platforms. In addition, the developer is often limited to receiving whatever trace information the operating system vendor chose to provide, which may be less than the developer wants under certain conditions. The developer can request that the operating system vendor add new trace information in the next version, but this requires waiting for the operating system vendor to add new software code, recompile the kernel, and ship a new version.

As an example, existing performance and trace logging kernel modules may not report all kernel activity and statistics required by developers using them. The goal of existing modules is to report specific hardware device statistics to user space, not general open kernel activity. MICROSOFT™ WINDOWS™ provides Event Tracing for Windows (ETW), but similar functionality is not available in a Linux environment. Thus, a WINDOWS™ developer providing a driver for both platforms may find that an elaborate debugging tool that works well on WINDOWS™ is ineffective when debugging the Linux version of the software.

### SUMMARY

A kernel trace system is described herein that acts as a kernel driver to insert traces into an open system kernel using existing kernel probe application-programming interfaces (APIs) and copies these events to an existing performance logging module for transfer to user space. The new module aggregates kernel traces to a logging module (e.g., a memory or performance logging module). Many operating systems already provide a facility for capturing existing trace information and logging that information to user space (the application level below the kernel) where applications can safely view and analyze the trace information. A performance logging module can be extended with the kernel trace system herein to include new events in an open kernel not originally included in the implementation of the performance logging module. In this way, the kernel trace system can cause events to be logged that were not logged in the kernel as provided by the operating system vendor, and can do so without requiring that a new version of the operating system be built. The probes can be inserted dynamically at run time on an existing kernel to extract additional trace information. Thus, the kernel trace system provides a way for software developers to extract more trace information from an existing kernel by dynamically adding new trace points and capturing information as the trace points execute while also leveraging existing event reporting mechanisms.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the kernel trace system, in one embodiment.

FIG. 2 is a flow diagram that illustrates processing of the kernel trace system to insert new trace probes to an operating system kernel, in one embodiment.

FIG. 3 is a flow diagram that illustrates processing of the kernel trace system to capture trace information from dynamically inserted trace probes, in one embodiment.

FIG. 4 is a data flow diagram that illustrates the flow of trace information dynamically captured by the kernel trace system, in one embodiment.

### DETAILED DESCRIPTION

A kernel trace system is described herein that acts as a kernel driver to insert traces into an open system kernel using existing kernel probe application-programming interfaces (APIs) and copies these events to an existing performance logging module for transfer to user space. The new module aggregates kernel traces to a logging module (e.g., a memory or performance logging module). Many operating systems already provide a facility for capturing existing trace information and logging that information to user space (the application level below the kernel) where applications can safely view and analyze the trace information. A performance logging module can be extended with the kernel trace system herein to include new events in an open kernel not originally included in the implementation of the performance logging module. For example, the system can insert assembly level software probes into particular functions of the kernel, so that when the machine code where the probe is located runs, the probe calls out to a trace mechanism to log information about the state of execution. In this way, the kernel trace system can cause events to be logged that were not logged in the kernel as provided by the operating system vendor, and can do so without requiring that a new version of the operating system be built. The probes can be inserted and removed dynamically at run time on an existing kernel to extract additional trace information.

The kernel trace system provides an open kernel driver module that inserts kernel probes to measure kernel activity and writes the probe information to an existing third party module for transfer to user space. Instead of using user space APIs to write events to the performance logging module (as these APIs would cause performance metrics to be changed and be inaccurate), the trace aggregation module writes directly to kernel space interfaces that exist to support the user space interface. A trace aggregation module can insert probes into the open kernel to detect context switches, file input/output (I/O) requests, process begin/end events, and task begin/end events. It is possible to add new probes to detect other kernel events. The probes may be inserted using an existing API provided by the operating system or through a probing mechanism provided by the system. An example implementation of the kernel trace system writes events to the Linux kernel module component of the Intel SVEN system. Probes are inserted in the kernel using the jprobe API. It is possible to support other trace reporting systems that implement kernel modules and other kernel probing APIs. Thus, the kernel trace system provides a way for software developers to extract more trace information from an existing kernel by dynamically adding new trace points and capturing information as the trace points execute while also leveraging existing event reporting mechanisms.

Using the kernel trace system, a software developer producing cross platform software code can produce similar trace output for any platform. Thus, for example, a MICROSOFT™ WINDOWS™ developer building a Linux version of a driver or application can cause Linux to produce a familiar ETW log that can be consumed by WINDOWS™ ETW performance and debugging tools. This allows performance automation investments on one platform to be leveraged on other platforms that do not natively provide the same support.

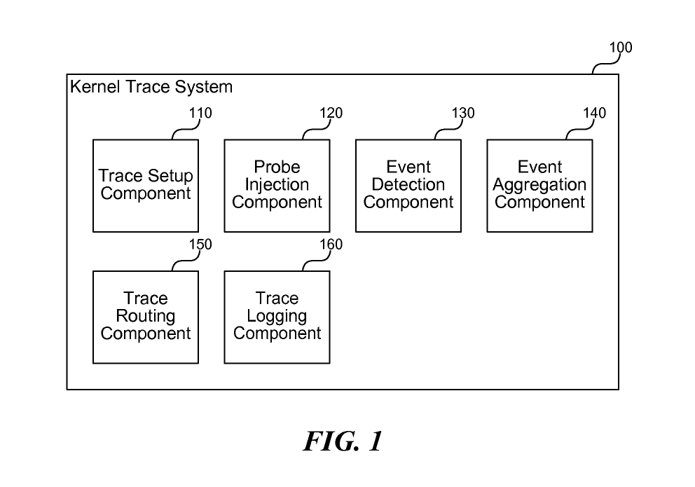

FIG. 1 is a block diagram that illustrates components of the kernel trace system, in one embodiment. The system 100 includes a trace setup component 110, a probe injection component 120, an event detection component 130, an event aggregation component 140, a trace routing component 150, and a trace logging component 160. Each of these components is described in further detail herein.

The trace setup component 110 receives information describing trace information to be captured in an operating system kernel that is not captured in a static compiled version of the kernel. For example, a developer may want to get trace information each time a file is accessed, and the operating system may not natively provide trace information at that point. The developer may identify one or more operating system APIs that will be invoked at the appropriate moment, and submit a request to the system 100 to inject probes at the beginning of such APIs to report the requested information. The component may receive a trace specification, such as a file specifying a list of API entry points for which traces are requested to be inserted.

The probe injection component 120 injects one or more software probes dynamically at runtime into the operating system kernel to add new trace code that will execute when the software code at an injection point executes. Probes may include assembly instructions, such as long jumps to a trace module that handles collection of trace information, then returns to the original code that follows the probe injection point. In this way the system 100 captures trace information as designated points in the operating system kernel are executed without adversely affecting operation of the operating system kernel. The probe injection component 120 may leverage facilities of the operating system to insert probes, such as Linux's kprobe and jprobe facilities, or may provide a proprietary mechanism for inserting probes into the kernel. The component 120 may also provide a facility to remove probes at the end of tracing activity so that the kernel can once again function without the inserted trace probes without requiring a reboot of the computer hardware on which the kernel is executing.

The event detection component 130 detects execution of software at a probe injection point where a software probe has been inserted to collect trace information. This may occur upon invocation of a particular API, function, or other code location of the operating system kernel. Upon arrival at the probe injection location, the component 130 detects execution of the probe. For example, the probe may include a long jump or other software code that causes invocation of a system 100 module that receives information related to the event. Because all of the stack frame and other information is intact upon detection of the event, the system 100 can capture information such as arguments of the present function, a stack trace, local variables of the present and prior stack frames, and so forth. This information may provide context related to what is going on in the kernel at the time of the trace.

The event aggregation component 140 aggregates multiple trace events reported by multiple injected probes into a central reporting module. The component 140 may include a trace aggregation module that receives each of the trace calls from injected probes. The component 140 may then format the information into a format expected and handled by an existing third party performance/trace logging module or a custom logging module of the system 100. Most operating systems already include some facility for logging performance and trace information, and simply lack all of the particular traces from which a developer may want to receive information. In this way, the system 100 can act as a liaison between the trace points suitable for any particular debugging or performance measurement task, and the existing trace infrastructure of the operating system. This allows the use of existing performance and logging tools but receiving an increased granularity and specificity of trace information tailored to the developer's current purpose.

The trace routing component 150 determines a reporting destination for aggregated trace events. The system 100 may have access to one or more logging facilities, such as the third party performance/trace logging module describing above, a custom logging module, one or more logging facilities provided by the operating system, and so on. Each of these logging facilities may provide one or more options for logging trace information to files, databases, or dynamically/programmatically reporting trace information in real time to other software components. The trace specification described herein may include information describing a destination for trace information selected by the developer using the system, and the trace routing component 150 is responsible for conveying incoming trace information to the selected destination.

The trace logging component 160 stores reported trace information persistently for further analysis. As described herein, trace logging may be provided by existing components of the operating system, a custom module, or a third party trace logging module. These components may log information to a file, database, or other persistent location. The value of tracing is often in how the captured trace information is used, and the system provides whatever trace information the developer selects from the operating system kernel, and then allows analysis of that information in whatever performance analysis and trace tools that the developer likes to use. The system 100 can help by formatting incoming trace information into a format expected by one or more trace analysis tools that the developer likes to use. For example, particular trace analysis tools may be designed to analyze comma-separated data, extensible markup language (XML) hierarchical data, particular events such as process start/stop or begin/end, and so forth. The trace logging component 160 stores reported trace information in the format identified by the user of the system 100.

The computing device on which the kernel trace system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, and so on or any other device with a kernel that allows for probes/injection.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

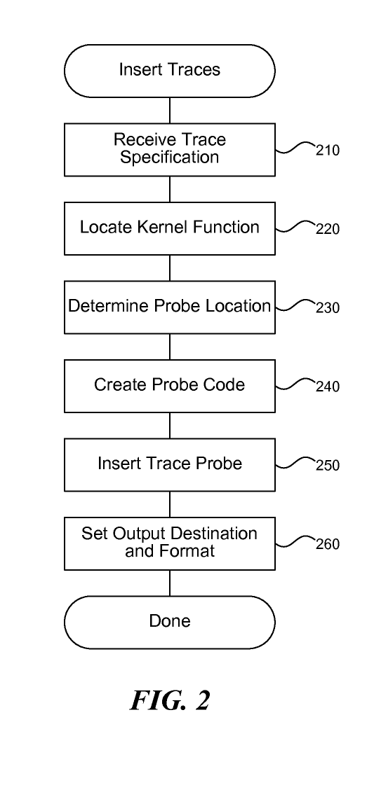

FIG. 2 is a flow diagram that illustrates processing of the kernel trace system to insert new trace probes to an operating system kernel, in one embodiment. Beginning in block 210, the system receives information describing one or more traces to dynamically collect from an operating system that does not natively provide the described traces. The specification may specify one or more operating system functions, APIs, or other entry points and specific data that the trace will collect (e.g., parameters, timestamp, thread/process identifier, and so on). The system may load this information when a driver installed to be loaded by the kernel loads, where the driver implements all or portions of the system described herein.

Continuing in block 220, the system locates one or more kernel entry points where the described trace information can be collected. The kernel may export a symbol table of available entry points or other information that allows the system to determine where to inject trace probes. In some cases, the system may be custom designed for each kernel and someone may manually discover available entry points, such as through disassembly and debugging the kernel. In other cases, the kernel may provide debug symbols, a jump table, or other well-known location that exports memory addresses or other specifications of entry point locations.

Continuing in block 230, the system determines one or more probe locations corresponding to the located one or more kernel entry points. These locations may include function entry points, and may skip beyond common function preamble such as stack frame setup and other function setup operations. Inserting the probe in this way allows the collection of stack frame based information, such as parameters passed into the function, local variables used within the function, and so forth. For some types of traces, the system may locate the end or exit point of the function (e.g., by looking for particular assembly code, like an X86 ret instruction), so that inserted traces can log the state/effects at the end of the function.

Continuing in block 240, the system creates one or more software probes corresponding to the determined one or more probe locations. Each probe may include a long jump with an address to be inserted in the original function, storage of the instruction that was originally located at the probe insertion point, and a data structure that determines which trace code is invoked to capture trace information. The system may insert a single jump instruction, jump to a location to run any amount of trace code, execute the instruction that was at the insertion location, and then jump back to the function so that the function can continue its execution as normal. In this way, the system gains the opportunity to capture any amount of desired trace information at any point in the operating system kernel, without needing a modified kernel from the operating system vendor to do so and without recompiling the kernel.

Continuing in block 250, the system inserts the created one or more software probes at the corresponding one or more probe locations. Insertion of the probe may include writing a long jump or other instruction at the appropriate location with an address that corresponds to the probe trace logic. The system may also store information for later removing the probe, so that the overwritten portion of the function can be placed back in its original state and any probe code can be deallocated.

Continuing in block 260, the system sets an output destination and format for trace information captured by the inserted software probes. In some cases, the system may route captured trace information to another kernel module that is designed to aggregate trace information collected from the kernel and to copy the information to user mode where normal applications (without kernel-level privileges) can gather and analyze the trace information either as it comes in or at a later time. Those of ordinary skill in the art will recognize various methods for communicating data between kernel and user space, such as allocating a common memory region, writing to commonly accessible file, opening a named pipe or socket, and so forth. The format selected may include a format that corresponds to a format understood by one or more existing performance and trace analysis tools, so that the system feeds new kernel trace information to existing tools for analyzing that information. In other cases, the system may select a custom format suitable for the developer's purpose that requested capture of the kernel trace information. After block 260, these steps conclude.

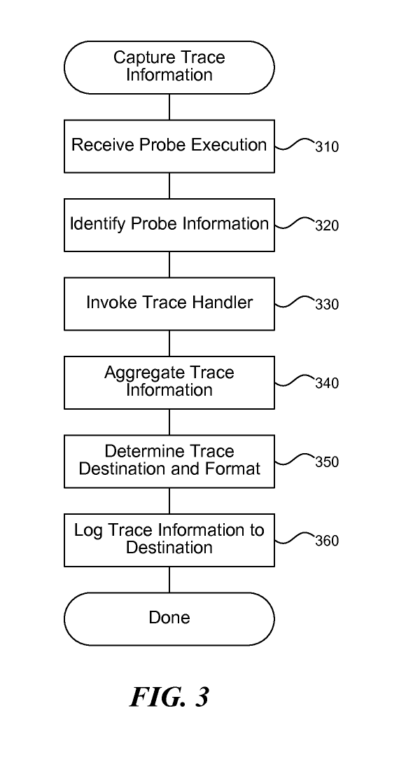

FIG. 3 is a flow diagram that illustrates processing of the kernel trace system to capture trace information from dynamically inserted trace probes, in one embodiment. Beginning in block 310, the system receives an indication that a location where a software probe was previously dynamically inserted into an operating system kernel has been reached for execution. For example, the system may have previously inserted a probe at the entry point of an operating system API and that API may have been invoked by software code such that the probe location has been reached. The probe location may include a long jump, call, or other instruction that invokes trace collection logic that implements the following steps. For example, the trace collection logic may be included as part of a driver installed in the operating system.

Continuing in block 320, the system identifies probe information related to the location reached for execution. The probe information may specify a trace handling function, a location to return upon completion of the trace handling, a format and log destination to be used for information collected from the location, and so forth. The probe information may also include information for removing the probe.

Continuing in block 330, the system invokes a trace handler that captures trace information associated with the reached location and then returns control to original operating system logic associated with the probe location. The captured trace information may include parameter information, local variable information, stack trace information, a timestamp, and any other relevant information selected by a developer that requested the trace information. The trace handler may enumerate available targets for aggregating trace information and invoke a trace target, such as a third party module for collecting trace information in the kernel and communicating it to one or more user mode trace analysis applications.

Continuing in block 340, the system aggregates trace information from multiple software probes in a trace aggregation module. The system may aggregate a variety of different traces and route them all to a trace destination for further processing. For example, the system may aggregate multiple trace probes related to file system activity within the kernel and may provide the aggregated information to a log module that copies the information into a particular format and stores the formatted information in a user-mode accessible persistent location (e.g., a file or memory region).

Continuing in block 350, the system determines a trace destination and format for the aggregated trace information. The destination may include another module, an API, or more logic of the system that stores the information in a log destination for further analysis. The format may include a file layout, memory layout, data structures to use for logging, and other format information that when applied to the trace information allows the trace information to be readily consumed by one or more available trace analysis tools.

Continuing in block 360, the system logs trace information to the determined destination and places the trace information in the determined format. This may write the information to another kernel driver, a file, a memory region shared with user mode applications, and so forth. This allows further analysis of the trace information at a later time and using one or more tools provided by the operating system or third parties for viewing and analyzing trace information. After block 360, these steps conclude.

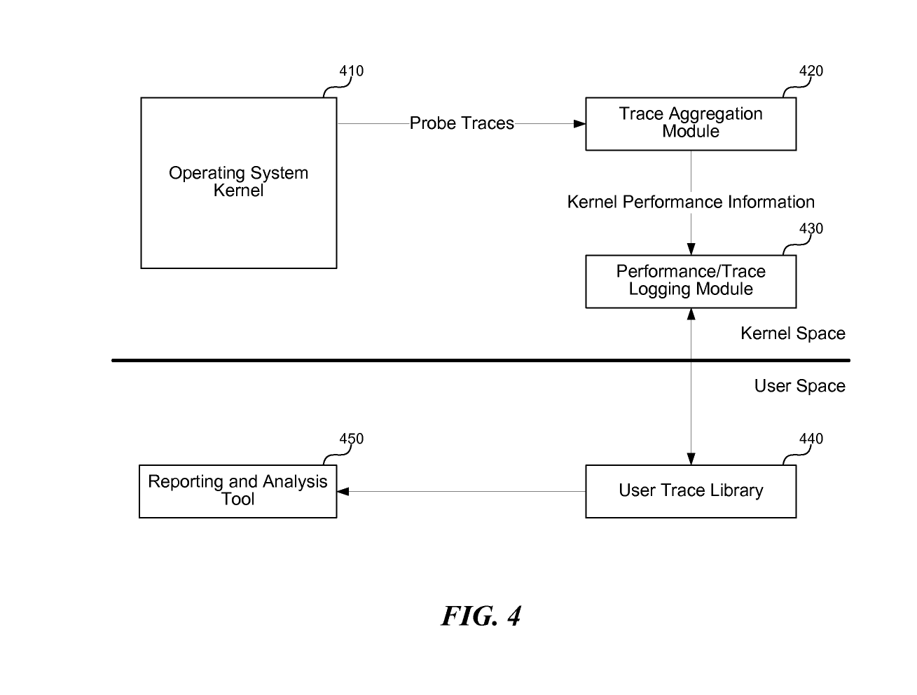

FIG. 4 is a data flow diagram that illustrates the flow of trace information dynamically captured by the kernel trace system, in one embodiment. Information captured within the operating system kernel 410 from one or more dynamically inserted software probes passes to a trace aggregation module 420. The module 420 may operate as a driver with access to kernel space where the operating system kernel 410 executes, and may use jprobe or other operating system facilities to insert traces into various points of execution of the operating system kernel 410. The trace aggregation module 420 passes the captured kernel trace information to a performance/trace logging module 430. In some cases, the module 430 may be one provided by the operating system or third party that is designed to convey trace information from kernel space to user space of the operating system. The performance/trace logging module 430 sends trace information across the kernel space/user space boundary to a user trace library 440. The user trace library 440 gathers trace information in user mode and provides the trace information to one or more applications, such as the reporting and analysis tool 450. The reporting and analysis tool 450 may provide a text-based log of kernel activity, one or more graphs for visualizing kernel activity, or other user interface for reporting the trace information.

In some embodiments, the kernel trace system operates with SVEN. SVEN is a library that logs events and provides timestamps in Linux/Unix-based operating systems. The system can aggregate detected kernel events through inserted kernel probes, using SVEN's hi-definition clock for tracking event times. The system can then provide a report with fine-grained accuracy as to when various events occur. SVEN also provides a mechanism for conveying reported performance and trace information to user mode applications for further analysis and reporting.

In some embodiments, the kernel trace system provides a dynamic environment that can be run to dynamically insert probes and capture trace information and then be closed to remove probes and turn off the additional trace information. For example, a developer may want to turn on the functionality of the system to diagnose a particular problem as the problem occurs, then turn off the system to avoid hindering performance of the computer on which the system is operating. This may be useful for production facilities in data centers or other situations where rebooting of the computer is not available or is not a good solution.

In some embodiments, the kernel trace system determines how long an operation took. For example, the system can capture high-definition clock times as described herein, and can get information from an operating system scheduler to know how long a particular thread or other operation was executing. This allows the system to measure performance of particular operations and to report the performance as a duration or other useful unit.

From the foregoing, it will be appreciated that specific embodiments of the kernel trace system have been described herein for purposes of illustration, but that various modifications may be made without deviating from the spirit and scope of the invention. Accordingly, the invention is not limited except as by the appended claims.

I/We claim:

1. A computer-implemented method to insert new trace probes into an operating system kernel, the method comprising:
receiving information describing one or more traces to dynamically collect from an operating system that does not natively provide the described traces;
determining one or more probe locations;
locating one or more kernel entry points where the described trace information can be collected;
creating one or more software probes corresponding to the determined one or more probe locations and located one or more kernel entry points;
setting an output destination and format for trace information captured by the inserted software probes; and
inserting the created one or more software probes at the corresponding one or more probe locations,
wherein the preceding steps are performed by at least one processor.

2. The method of claim 1 wherein receiving information describing traces comprises specifying one or more operating system functions, application-programming interfaces (APIs), or other entry points from which to collect information.

3. The method of claim 1 wherein receiving information describing traces comprises specifying specific data that the trace will collect.

4. The method of claim 1 wherein receiving information describing traces comprises loading a kernel mode driver into the operating system that specifies the traces.

5. The method of claim 1 wherein locating kernel entry points comprises identifying a symbol table exported by the kernel of available entry points in the kernel.

6. The method of claim 1 wherein locating kernel entry points comprises locating a memory address associated with each entry point.

7. The method of claim 1 wherein determining probe locations comprises skipping beyond stack frame setup logic to locate the probe within a body of a function.

8. The method of claim 1 wherein determining probe locations comprises invoking a facility provided by the operating system for inserting probes into the kernel.

9. The method of claim 1 wherein determining probe locations comprises locating and end or exit point of a function so that inserted traces can log the state at the end of the function.

10. The method of claim 1 wherein creating software probes comprises determining at least one of a long jump with an address to be inserted in the original function, storage of an instruction that was originally located at the probe insertion point, and a data structure that determines which trace code is invoked to capture trace information.

11. The method of claim 1 wherein creating software probes comprises creating a probe that inserts a jump instruction, jumps to a location to run trace code, executes the instruction that was at the insertion location, and then jumps back to the function so that the function can continue its execution as normal.

12. The method of claim 1 wherein inserting probes comprises writing a long jump or other instruction at the appropriate location with an address that corresponds to probe trace logic.

13. The method of claim 1 wherein inserting probes comprises storing information for later removing the probe, so that the overwritten portion of the function can be placed back in its original state and any probe code can be deallocated.

14. The method of claim 1 wherein setting an output destination and format comprises routing captured trace information to another kernel module that is designed to aggregate trace information collected from the kernel and to copy the information to user mode where applications can gather and analyze the trace information.

15. A computer system for dynamically tracing events in a kernel at run time, the system comprising:
a processor and memory configured to execute software instructions embodied within the following components;
a trace setup component that receives information describing trace information to be captured in an operating system kernel that is not captured in a static compiled version of the kernel;
a probe injection component that injects one or more software probes dynamically at run time into the operating system kernel to add new trace code that will execute upon execution of software code at an injection point;
an event detection component that detects execution of software at a probe injection point where a software probe has been inserted to collect trace information;
an event aggregation component that aggregates multiple trace events reported by multiple injected probes into a central reporting module;
a trace routing component that determines a reporting destination for aggregated trace events; and
a trace logging component that stores reported trace information persistently for further analysis.

16. The system of claim 15 wherein the probe injection component invokes facilities of the operating system to insert probes into the kernel.

17. The system of claim 15 wherein the probe injection component provides a facility to remove probes at the end of tracing activity so that the kernel can once again function without the inserted trace probes without requiring a reboot of the computer hardware on which the kernel is executing.

18. The system of claim 15 wherein the event aggregation component formats the information into a format expected and handled by an existing performance/trace logging module that allows the use of existing performance and logging tools for captured trace information.

19. A computer-readable storage medium comprising instructions for controlling a computer system to capture trace information from dynamically inserted trace probes, wherein the instructions, upon execution, cause a processor to perform actions comprising:
receiving an indication that a location where a software probe was previously dynamically inserted into an operating system kernel has been reached for execution;
identifying probe information related to the location reached for execution;
invoking a trace handler that captures trace information associated with the reached location and then returns control to original operating system logic associated with the probe location;
aggregating trace information from multiple software probes in a trace aggregation module;
determining a trace destination and format for the aggregated trace information; and
logging trace information to the determined destination and places the trace information in the determined format.

20. The medium of claim 19 wherein identifying probe information comprises identifying a trace handling function, a location to return upon completion of the trace handling, and a format and log destination to be used for information collected from the location.
